(19) United States
(12) Patent Application Publication
(10) Pub. No.: US 2024/0317098 A1
(43) Pub. Date: Sep. 26, 2024

(54) BATTERY CONTROL APPARATUS

(71) Applicant: ISUZU MOTORS LIMITED, Yokohama-shi (JP)

(72) Inventors: Takuya KIKUCHI, Fujisawa-shi (JP); Keiji FURUMACHI, Fujisawa-shi (JP); Kenji MORIKAWA, Fujisawa-shi (JP); Shigeki IIJIMA, Fujisawa-shi (JP); Hitoshi MIYAGAWA, Fujisawa-shi (JP); Yuta IKEDA, Fujisawa-shi (JP)

(21) Appl. No.: 18/438,744

(22) Filed: Feb. 12, 2024

(30) Foreign Application Priority Data
Feb. 28, 2023 (JP) 2023-029591

(51) Int. Cl. B60L 53/62; H01M 10/615; H01M 10/625; H01M 10/63; H02J 7/00

(52) U.S. Cl. CPC B60L 53/62; H01M 10/615; H01M 10/625; H01M 10/63; H02J 7/007194; B60L 2240/545; H01M 2220/20

(57) ABSTRACT

Provided is a battery control apparatus capable of preventing battery deterioration from being accelerated. The battery control apparatus is in a vehicle including a battery and a heater, where the battery is a battery to which external power is supplied, the battery supplies power to a motor for vehicle travel, and the heater heats the battery. The battery control apparatus includes: an acquisition section that acquires a temperature of the battery; and a control section that executes, in a case where the temperature of the battery, where the temperature has been acquired, is equal to or lower than a predetermined threshold, control such that the external power is not supplied to the battery and each power of the external power and the power of the battery is supplied to the heater.

### CROSS REFERENCE TO RELATED APPLICATIONS

The present application is based on a Japanese Patent Application (Japanese Patent Application No. 2023-029591), filed on Feb. 28, 2023, the entire content of which is incorporated herein by reference.

### TECHNICAL FIELD

The present disclosure relates to a battery control apparatus.

### BACKGROUND ART

In an electric vehicle (EV), a motor for vehicle travel and a battery for supplying power to the motor are mounted. External power for charging is supplied from an external power supply to the battery.

For example, a charge control apparatus is disclosed which is mounted in an EV and includes: a sensor that detects a physical quantity related to charging; an acquisition section that acquires a detection result of the sensor; and a control section that controls an external power supply, based on the detection result of the sensor and a target charge quantity, such that external power for charging is supplied to a battery (for example, see Patent Literature (hereinafter referred to as “PTL”) 1).

### CITATION LIST

### Patent Literature

PTL 1
Japanese Patent Application Laid-Open No. 2022-068661

### SUMMARY OF INVENTION

### Technical Problem

Incidentally, there is a problem in that when a battery is charged, for example, at a low temperature equal to or lower than 0° C., lithium ions released from the positive electrode are deposited on the surface of the negative electrode, the resistance increases, and the battery capacity decreases, and thus, battery deterioration is accelerated, which may lead to an internal short circuit.

An object of the present disclosure is to provide a battery control apparatus capable of preventing battery deterioration from being accelerated.

### Solution to Problem

In order to achieve the above-mentioned object, a battery control apparatus in the present disclosure is a battery control apparatus in a vehicle including a battery and a heater, where the battery is a battery to which external power is supplied, the battery supplies power to a motor for vehicle travel, and the heater heats the battery. The battery control apparatus includes: an acquisition section that acquires a temperature of the battery; and a control section that executes, in a case where the temperature of the battery, where the temperature has been acquired, is equal to or lower than a predetermined threshold, control such that the external power is not supplied to the battery and each power of the external power and the power of the battery is supplied to the heater.

### Advantageous Effects of Invention

According to the present disclosure, it is possible to prevent battery deterioration from being accelerated.

### BRIEF DESCRIPTION OF DRAWINGS

FIG. 1 illustrates an example of an electric power system of an electric vehicle in an embodiment of the present disclosure;

FIG. 2 functionally illustrates an example of a battery control apparatus in the electric power system in the present embodiment; and

FIG. 3 is a flowchart illustrating an exemplary operation of the battery control apparatus in the present embodiment.

### DESCRIPTION OF EMBODIMENTS

Hereinafter, an embodiment of the present disclosure will be described with reference to the accompanying drawings.

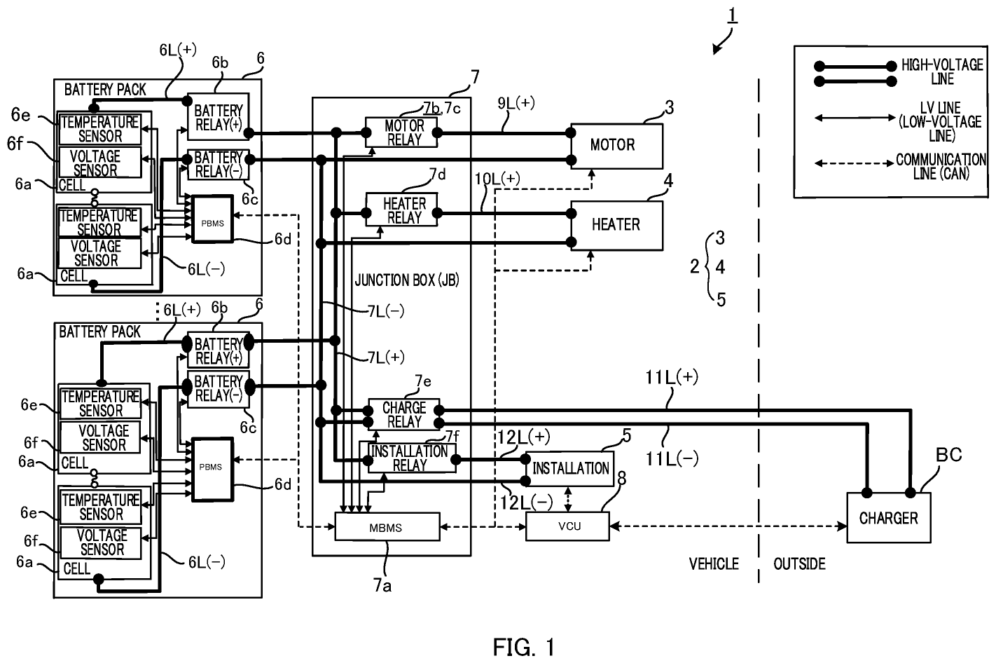

FIG. 1 illustrates an example of electric power system 1 of an electric vehicle (EV) in an embodiment of the present disclosure. Note that, in the following description, a case where the present disclosure is applied to a commercial vehicle such as a truck or a bus will be described, but the present disclosure is not limited thereto and may be applied to a vehicle such as a passenger car.

As illustrated in FIG. 1, external load 2 including motor 3, heater 4 and installation 5, for example; a plurality of battery packs 6; and junction box (JB) 7; and vehicle control unit (VCU) 8 are disposed in electric power system 1. Further, FIG. 1 illustrates charger BC disposed outside the EV. Note that, one or a plurality of battery packs 6 corresponds to the “battery/batteries” in the present disclosure. Connection of charger BC to electric power system 1 allows power to be supplied to the batteries via junction box 7. Further, charging to the battery is released by detaching charger BC from electric power system 1. In the following description, charger BC may be referred to as an “external power supply”. Further, the power supplied from charger BC may be referred to as “external power”.

Motor 3 is a motor for travel, which is driven by power being supplied from battery packs 6 to motor 3.

Heater 4 is a heater which heats battery packs 6 themselves by power being supplied from battery packs 6 to heater 4.

Installation 5 is an apparatus which is mounted in the EV and operates by power being supplied from battery packs 6 to installation 5. Installation 5 encompasses, for example, a loading platform lifting apparatus, a refrigerator, and a freezer.

Each of the plurality of battery packs 6 has the same configuration, and thus, one battery pack 6 among the plurality of battery packs 6 will be described as a representative. Battery pack 6 includes a plurality of cells 6a, battery relay(+) 6b, battery relay(−) 6c, and, battery pack management system (PBMS) 6d.

One terminal of battery relay(+) 6b is connected to the positive terminal of cell 6a via high-voltage line 6L(+). The other terminal of battery relay(+) 6b is connected to high-voltage line 7L(+). One terminal of battery relay(−) 6c is connected to the negative terminal of cell 6a via high-voltage line 6L(−). The other terminal of battery relay(−) 6c is connected to high-voltage line 7L(−).

Cell 6a includes temperature sensor 6e and voltage sensor 6f. Temperature sensor 6e detects the cell temperature. Temperature sensor 6e outputs a detection result (cell temperature) to PBMS 6d. Voltage sensor 6f detects the cell voltage. Voltage sensor 6f outputs a detection result (cell voltage) to PBMS 6d.

Based on both the inputted cell temperatures and the inputted cell voltages, PBMS 6d controls battery relay(+) 6b such that battery relay(+) 6b performs connection/disconnection between high-voltage line 6L(+) and high-voltage line 7L(+), and controls battery relay(−) 6c such that battery relay(−) 6c performs connection/disconnection between high-voltage line 6L(−) and high-voltage line 7L(−).

For example, PBMS 6d calculates, based on the open circuit voltage (OCV) and the cell temperatures in battery pack 6, the SOC (state of charge) by referring to a curve that represents the relationship between the SOC and the OCV, which is set for each cell temperature.

Junction box (JB) 7 is disposed between battery pack 6 and external load 2 as well as charger BC. JB 7 includes master battery management system (MBMS) 7a and relay circuit 7b.

Master battery management system (MBMS) 7a and PBMS 6d are connected via a communication line (CAN). MBMS 7a acquires the state of battery pack 6 (for example, cell temperatures, cell voltages, and SOCs) from PBMS 6d each time a fixed period of time has elapsed. MBMS 7a transmits each control signal of battery relay(+) 6b and battery relay(−) 6c to PBMS 6d.

MBMS 7a controls relay circuit 7b based on the acquired state of battery pack 6.

Relay circuit 7b includes motor relay 7c, heater relay 7d, charge relay 7e, and installation relay 7f.

One terminal of motor relay 7c is connected to high-voltage line 7L(+). The other terminal of motor relay 7c is connected to motor 3 via high-voltage line 9L(+) and an inverter (not illustrated). High-voltage line 7L(−) is connected to motor 3 via an inverter. MBMS 7a controls motor relay 7c such that motor relay 7c performs connection/disconnection between high-voltage line 7L(+) and high-voltage line 9L(+).

One terminal of heater relay 7d is connected to high-voltage line 7L(+). The other terminal of heater relay 7d is connected to heater 4 via high-voltage line 10L(+). High-voltage line 7L(−) is connected to heater 4. MBMS 7a controls heater relay 7d based on the state of battery pack 6 such that heater relay 7d performs connection/disconnection between high-voltage line 7L(+) and high-voltage line 10L(+).

One terminal (+) of charge relay 7e is connected to high-voltage line 7L(+). The other terminal (+) of charge relay 7e is connected to charger BC via high-voltage line 11L(+). One terminal (−) of charge relay 7e is connected to high-voltage line 7L(−). The other terminal (−) of charge relay 7e is connected to charger BC via high-voltage line 11L(−). MBMS 7a controls charge relay 7e based on the state of battery pack 6 such that charge relay 7e performs connection/disconnection between high-voltage line 7L(+) and high-voltage line 11L(+) as well as performs connection/disconnection between high-voltage line 7L(−) and high-voltage line 11L(−).

One terminal of installation relay 7f is connected to high-voltage line 7L(+). The other terminal of installation relay 7f is connected to installation 5 via high-voltage line 12L(+). High-voltage line 12L(−) is connected to installation 5. MBMS 7a controls installation relay 7f based on a control signal of vehicle control unit (VCU) 8 corresponding to the state of installation 5, or the like, such that installation relay 7f performs connection/disconnection between high-voltage line 7L(+) and high-voltage line 12L(+).

Vehicle control unit (VCU) 8 controls installation 5 based on information indicating the state of installation 5. VCU 8 judges the state of the EV and executes control such that the EV is maintained in the optimum state. Specifically, in a case where VCU 8 detects an abnormality in the EV, VCU 8 controls motor 3 such that the EV stops. Further, VCU 8 controls supply power from battery pack 6 to motor 3 by changing the voltage between battery pack 6 and motor 3. Further, VCU 8 controls supply power from battery pack 6 to heater 4 by changing the voltage between battery pack 6 and heater 4. Further, VCU 8 controls charger BC such that the charging power when battery pack 6 is charged does not exceed the chargeable power.

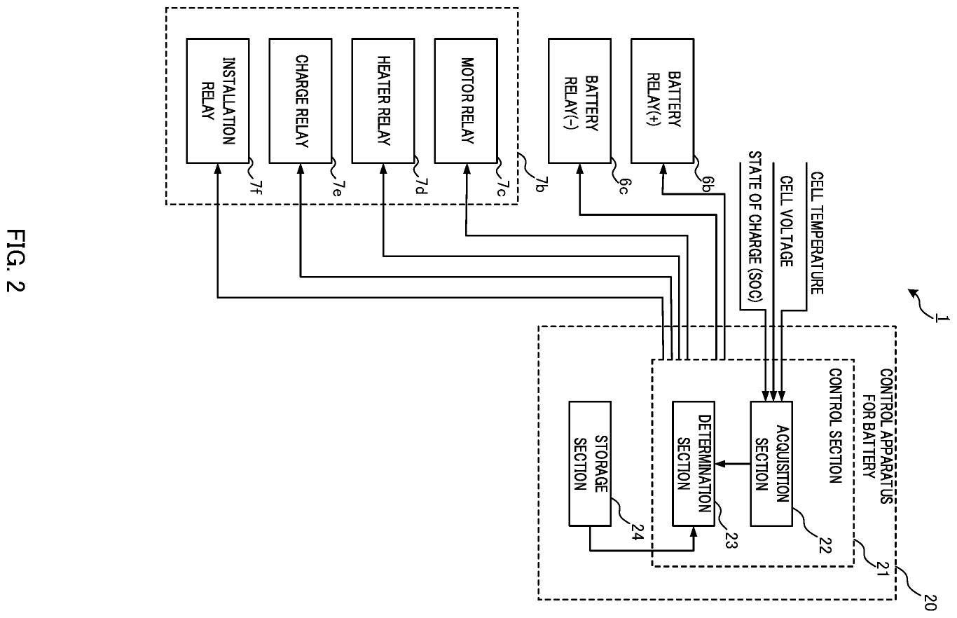

Next, a specific example of electric power system 1 will be described with reference to FIG. 2. FIG. 2 functionally illustrates an example of a battery control apparatus in the electric power system.

Control apparatus 20 for a battery monitors the state of battery pack 6 such as voltages, currents, temperatures, and states of charge (SOCs) in battery pack 6 as well as performs control for safe and efficient use of battery pack 6.

Control apparatus 20 includes control section 21 and storage section 24. In FIG. 2, the arrows indicate main data flows, and there may be a data flow(s) not illustrated in FIG. 2. In FIG. 2, each functional block does not indicate a structure of hardware (apparatus) units, but a structure of functional units. For this reason, the functional blocks illustrated in FIG. 2 may be implemented within a single apparatus, or may be implemented separately in a plurality of apparatuses. Transfer of data between functional blocks may be performed via an arbitrary means such as a data bus, a controller area network (CAN bus), or the like.

Storage section 24 is a storage apparatus such as a read only memory (ROM) which stores a basic input output system (BIOS) or the like of a computer realizing control apparatus 20, a random access memory (RAM) which becomes a workspace for control apparatus 20, an operating system (OS), an application program, and a hard disk drive (HDD) and a solid state drive (SSD) which store various information to be referred to when the application program is executed.

Further, storage section 24 stores first and second thresholds of each cell temperature. The first and second thresholds are according to the performance of battery pack 6, the materials of which battery pack 6 is formed, and/or the like, and are set based on an experiment(s) and/or a simulation(s). In the present embodiment, the first threshold is a temperature at which deterioration of battery pack 6 may be accelerated by charging battery pack 6 when each cell temperature is equal to or lower than the first threshold. For example, the first threshold is a temperature (for example, 0° C.) at which lithium ions released from the positive electrode at the time of charging are deposited on the surface of the negative electrode. The second threshold is a predetermined temperature (for example, a temperature suitable for charging/discharging, at which the battery reaction resistance is sufficiently low) in a range of operation temperatures at which battery pack 6 is allowed to operate. Note that, for each cell temperature, a detection error occurs depending on the detection accuracy of the temperature sensor, and thus, each of the first and second thresholds may have a predetermined temperature range.

Control section 21 is a processor such as a central processing unit (CPU) and a graphics processing unit (GPU) of control apparatus 20, and functions as acquisition section 22 and determination section 23 by executing a program stored in storage section 24.

Note that, FIG. 2 illustrates an example when control apparatus 20 is formed of a single apparatus. Having said that, control apparatus 20 may be implemented by computational resources such as, for example, a plurality of processors or memories. In this case, each section forming control section 21 is implemented by at least one of a plurality of different processors executing a program. Note that, in a case where control apparatus 20 is formed of a single apparatus, for example, control apparatus 20 may be formed of all of battery pack management system (PBMS) 6d, master battery management system (MBMS) 7a, and vehicle control unit (VCU) 8 that are illustrated in FIG. 1. In a case where control apparatus 20 is formed of a plurality of apparatuses, for example, control apparatus 20 may be formed of PBMS 6d, MBMS 7a, and VCU 8 individually, or may be formed of a combination of two apparatuses among PBMS 6d, MBMS 7a, and VCU 8, and the other apparatus.

Acquisition section 22 acquires data indicating the states of a plurality of battery packs 6 including cell temperatures, cell voltages, and states of charge (SOCs) from respective PBMSs 6d (see FIG. 1). The data acquired by acquisition section 22 is stored in storage section 24.

Determination section 23 determines whether each cell temperature is equal to or lower than the first threshold. In a case where each cell temperature is equal to or lower than the first threshold, control section 21 executes control such that external power is not supplied to battery pack 6 and each power of external power and power of battery pack 6 is supplied to heater 4. Thus, it is possible to suppress deterioration and prevent internal short circuits. Further, the cell itself is discharged, and thus, self-heating of the cell occurs. As a result, it is possible to cause each cell temperature to reach a temperature (a temperature at which deposition of lithium does not occur) higher than the first threshold earlier, and thus, battery pack 6 can be operated quickly.

Further, in a case where each cell temperature is higher than the first threshold and is equal to or lower than the second threshold higher than the first threshold, control section 21 executes control such that external power is supplied to each of battery pack 6 and heater 4. Thus, it is possible to charge battery pack 6. Further, it is possible to raise each cell temperature to a suitable temperature.

Further, in a case where each cell temperature is higher than the second threshold, control section 21 executes control such that external power is supplied to battery pack 6 and is not supplied to heater 4. Thus, it is possible to charge battery pack 6. Further, it is possible to maintain each cell temperature at a suitable temperature.

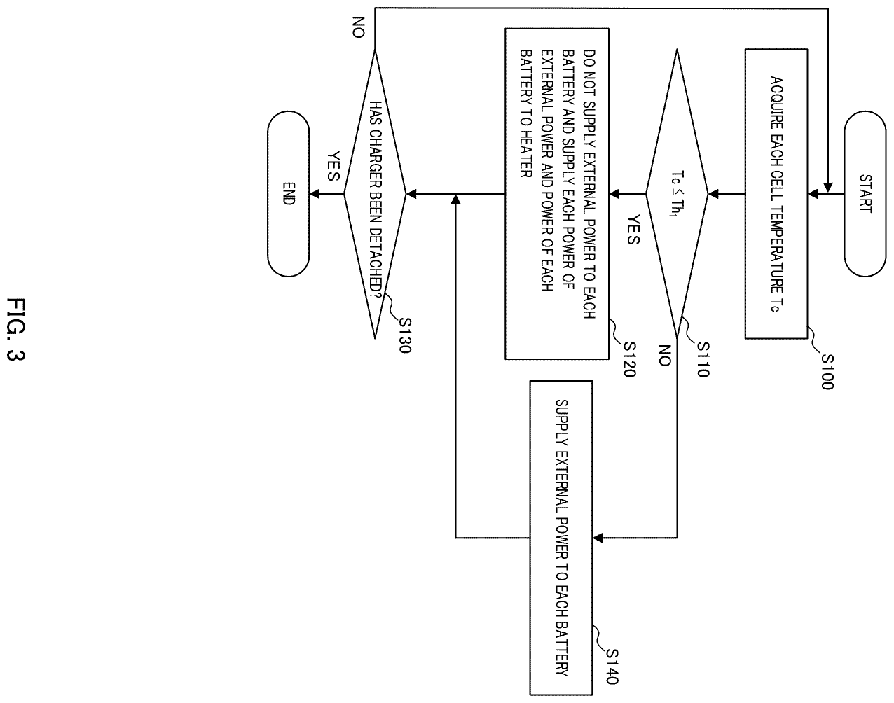

Next, an exemplary operation of control apparatus 20 in the present embodiment will be described with reference to FIG. 3. FIG. 3 is a flowchart illustrating an exemplary operation of control apparatus 20 in the present embodiment. This flowchart is started in a case where charger BC is connected to electric power system 1. In the following description, a case where the first threshold (indicated with “TH₁” in FIG. 3) is set and the second threshold is not set will be described. Further, a description will be given on the assumption that the CPU executes each function of control apparatus 20.

First, in step S100, the CPU acquires each cell temperature Tc from PBMS 6d.

Next, in step S110, the CPU determines whether each cell temperature Tc is equal to or lower than first threshold TH₁ (Tc≤TH₁). In a case where each cell temperature Tc is equal to or lower than first threshold TH₁ (step S110: YES), the processing transitions to step S120. In a case where each cell temperature Tc is not equal to or lower than first threshold TH₁ (step S110: NO), the processing transitions to step S140.

In step S120, the CPU executes control such that external power is not supplied to each battery and each power of external power and power of each battery is supplied to heater 4. Then the processing transitions to step S130.

In step S130, the CPU determines whether charger BC has been detached from electric power system 1. In a case where charger BC has been detached (step S130: YES), this flowchart ends. In a case where charger BC has not been detached (step S130: NO), the processing returns before step S100.

In step S140, the CPU executes control such that external power is supplied to each battery. Then the processing transitions to step S130.

The battery control apparatus according to the embodiment described above is control apparatus 20 for a battery, in an EV including battery pack 6 and heater 4, where battery pack 6 is a battery pack to which external power, which is power from charger BC (external power supply), is supplied, battery pack 6 supplies power to motor 3 for vehicle travel, and heater 4 heats battery pack 6. Control apparatus 20 includes: acquisition section 22 that acquires a cell temperature; and control section 21 that executes, in a case where the cell temperature having been acquired is equal to or lower than a predetermined threshold, control such that the external power is not supplied to battery pack 6 and each power of the external power and the power of battery pack 6 is supplied to heater 4.

The configuration described above makes it possible to prevent a decrease in the battery from being accelerated since external power is not charged to battery pack 6 when each cell temperature is equal to or lower than the first threshold. Further, the configuration described above enables safety measures. Further, since the cell itself is discharged, and thus, self-heating of the cell occurs, battery pack 6 can be operated quickly. Further, since charger BC and electric power system 1 are connected via the charge relay, a detachment work is required even in a case where each cell temperature is equal to or lower than the first threshold.

Further, in the battery control apparatus in the embodiment described above, the predetermined threshold is a temperature at which lithium ions released from the positive electrode at the time of charging are deposited on the surface of the negative electrode. Thus, it is possible to prevent deposition of lithium from occurring, it is possible to prevent battery deterioration from being accelerated, and further safety measures are possible.

Note that, in the battery control apparatus in the embodiment described above, in a case where the cell temperature is higher than the predetermined threshold and is equal to or lower than a predetermined second threshold higher than the predetermined threshold, control section 21 may execute control such that the external power is supplied to each of battery pack 6 and heater 4. Thus, each cell temperature relatively quickly reaches a temperature that is equal to or higher than the first threshold and equal to or lower than the second threshold, and thus, it is possible to charge battery pack 6. Further, it is possible to raise each cell temperature to a suitable temperature.

Further, in the battery control apparatus in the embodiment described above, the predetermined second threshold is a predetermined value in a range of operation temperatures at which battery pack 6 is allowed to operate. Note that, each cell temperature may be raised to a temperature higher than the second threshold due to self-heating of the battery associated with charging/discharging.

Further, in the battery control apparatus in the embodiment described above, in a case where the cell temperature is higher than the predetermined second threshold, control section 21 may execute control such that the external power is supplied to battery pack 6 and is not supplied to heater 4. Each cell temperature may be raised to a temperature higher than the second threshold due to self-heating of the battery associated with charging/discharging.

In addition, any of the embodiment described above is only illustration of an exemplary embodiment for implementing the present disclosure, and the technical scope of the present disclosure shall not be construed limitedly thereby. That is, the present disclosure can be implemented in various forms without departing from the gist or the main features thereof.

The present application is based on a Japanese Patent Application (Japanese Patent Application No. 2023-029591), filed on Feb. 28, 2023, the entire content of which is incorporated herein by reference.

### INDUSTRIAL APPLICABILITY

The present disclosure is suitably utilized in an electric vehicle including a battery control apparatus required to prevent battery deterioration from being accelerated.

1. A battery control apparatus in a vehicle, the vehicle including a battery and a heater, the battery being a battery to which external power is supplied, the battery supplying power to a motor for vehicle travel, the heater heating the battery, the battery control apparatus comprising:
an acquisition section that acquires a temperature of the battery; and
a control section that executes, in a case where the temperature of the battery is equal to or lower than a predetermined threshold, control such that the external power is not supplied to the battery and each power of the external power and the power of the battery is supplied to the heater, the temperature having been acquired.

2. The battery control apparatus according to claim 1, wherein the predetermined threshold is a temperature corresponding to a temperature at which deposition of lithium contained in the battery occurs.

3. The battery control apparatus according to claim 1, wherein in a case where the temperature of the battery is higher than the predetermined threshold and is equal to or lower than a predetermined second threshold, the control section executes control such that the external power is supplied to each of the battery and the heater, the predetermined second threshold being higher than the predetermined threshold.

4. The battery control apparatus according to claim 3, wherein the predetermined second threshold is a predetermined temperature in a range of operation temperatures at which the battery is allowed to operate.

5. The battery control apparatus according to claim 3, wherein in a case where the temperature of the battery is higher than the predetermined second threshold, the control section executes control such that the external power is supplied to the battery and is not supplied to the heater.
